(19) United States
(12) Patent Application Publication
(10) Pub. No.: US 2026/0291542 A1
(43) Pub. Date: Sep. 24, 2026

(54) METHODS, ARCHITECTURES, APPARATUSES AND SYSTEMS FOR DETECTING AND REPORTING CHIRP MISMATCH

(71) Applicant: InterDigital Patent Holdings, Inc., Wilmington, DE (US)

(72) Inventors: Ibrahim Hemadeh, Hemel Hempstead (GB); Yasser Mestrah, London (GB); Mohammad Heggo, London (GB); Javier Lorca Hernando, Madrid (ES); Arman Shojaeifard, London (GB); Alain Mourad, Ascot (GB); Pankaj Kumar, Southampton (GB); Mohammed El-Hajjar, Southampton (GB)

(21) Appl. No.: 19/087,054

(22) Filed: Mar. 21, 2025

(51) Int. Cl. H04B 1/69

(52) U.S. Cl. CPC H04B 1/69; H04B 2001/6912

(57) ABSTRACT

Methods, architectures, apparatuses, systems, devices, and computer products are provided for detecting and reporting chirp mismatch using a wireless transmit/receive unit (WTRU). WTRU methods and systems include receiving, from a wireless network, chirp configuration information for sensing and performing one or more measurements based on the chirp configuration information. The WTRU methods and systems further include determining a chirp parameter mismatch based on the one or more measurements and transmitting, to the wireless network, a measurement report indicating the chirp parameter mismatch.

### BACKGROUND

Cellular network technology such as 5G uses orthogonal frequency division modulation (OFDM) for data communication. While OFDM may offer high spectral efficiency and robustness against multipath fading channels with flexible time and frequency allocations for data communications, OFDM may have disadvantages for sensing, including limited range resolution, sensitivity to doppler shifts, and less adaptability to different sensing tasks. Modifying cellular technology to use different signals for data communications and sensing presents various challenges.

### SUMMARY

The present disclosure is generally directed to the fields of communications, software and encoding/decoding, including, for example, to methods, architectures, apparatuses, systems related to chirp-based sensing, including detecting and reporting chirp mismatch. This disclosure may provide a method performed by a wireless transmit/receive unit (WTRU) and a WTRU device for detecting and reporting chirp mismatch. In accordance with certain embodiments of the present disclosure, the WTRU receives, from a wireless network, chirp configuration information for sensing. The WTRU may perform one or more measurements based on the chirp configuration information. The WTRU may determine a chirp parameter mismatch based on the one or more measurements and transmit, to the wireless network, a measurement report indicating the chirp parameter mismatch.

In some embodiments, the chirp configuration information indicates at least one of a chirp rate, a chirp duration, a chirp bandwidth, a chirp frequency, a chirp start time, or a chirp end time.

In some embodiments, the one or more measurements are associated with one or more of: of a chirp frequency, a chirp start time, a chirp end time, a start time of a frequency, an end time of a frequency, an effective chirp rate, a measured chirp rate to configured chirp rate ratio, or chirp linearity.

In some embodiments, determining the chirp parameter mismatch comprises determining 1) a difference between a measured chirp rate and a configured chirp rate, or 2) a ratio between the measured chirp rate and the configured chirp rate.

In some embodiments, the measurement report indicates that the difference or the ratio between the measured chirp rate and the configured chirp rate is above or below a threshold.

In some embodiments, the WTRU performs a calibration based on the chirp parameter mismatch, wherein the calibration comprises one of replacing one or more parameters of the chirp configuration information with measured chirp information or performing one or more sensing measurements using the measured chirp information.

In some embodiments, the WTRU performs de-chirping of a received chirp reference signal based on the chirp configuration information.

In some embodiments, the measurement report indicates measured chirp information.

In some embodiments, the measurement report indicates that the chirp parameter mismatch is above or below a threshold.

In some embodiments, the measurement report indicates at least one of the one or more measurements, calibration information, a recommendation for a chirp configuration update, or post-calibration measurements.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (Figs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an illustrative diagram of a chirp-based signal transmitted by a transmitter, reflected at a target, and received at a receiver, as well as the resulting time and frequency differences between the transmitted and received signals, according to some embodiments of this disclosure;

FIG. 3 is an illustrative diagram of an example chirp rate mismatch, according to some embodiments of this disclosure;

FIG. 4 is an illustrative diagram of an estimated range root-mean-square error (RMSE) for a chirp signal and a chirp signal multiplexed with OFDM, according to some embodiments of this disclosure;

FIG. 5 is an illustrative diagram of a set of preconfigured chirp frequencies correlated with the received chirp-based signal and the correlation level with respect to a threshold, according to some embodiments of this disclosure;

FIG. 6 is an illustrative flow diagram of steps for a WTRU receiving chirp-based reference signal(s) (RS(s)) and performing chirp measurements, calibration if mismatch is detected, and post-calibration measurements, according to some embodiments of this disclosure;

FIG. 7 is an illustrative diagram of the mismatch between a transmitted chirp signal and a received chirp signal as measured by a receiver, as a result of hardware imperfections and/or channel variations, according to some embodiments of this disclosure;

FIG. 8 is an illustrative diagram of the mismatch of the configured and measured chirp rates in a time vs. frequency representation, according to some embodiments of this disclosure;

FIG. 9 is an illustrative diagram of the set of measured characteristics of the received chirp-based signal, according to some embodiments of this disclosure; and

FIG. 10 is an illustrative flow diagram of steps for detecting and reporting chirp mismatch, according to some embodiments of this disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

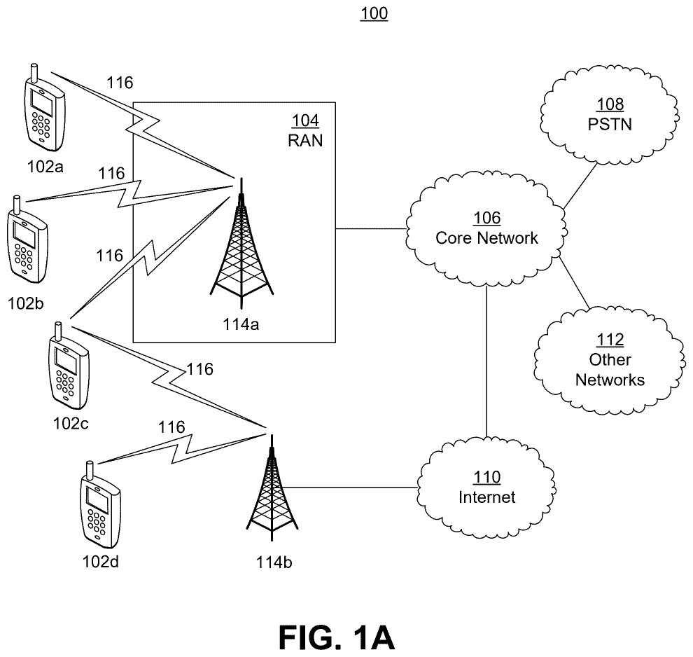

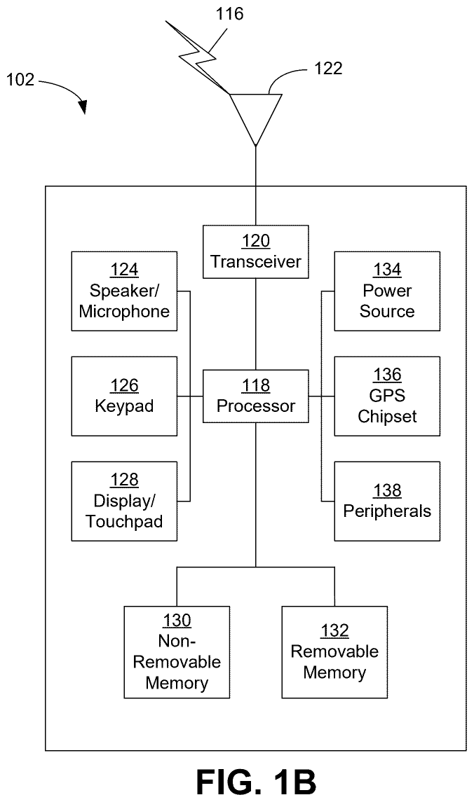

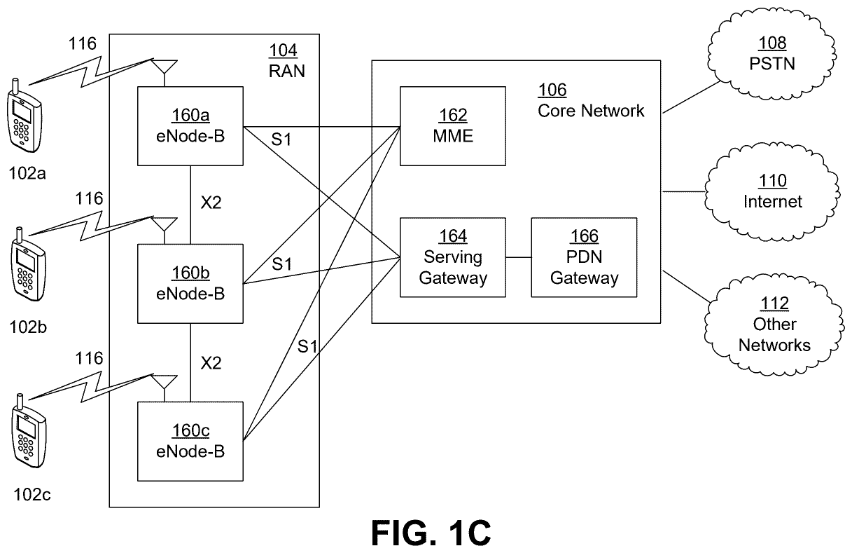

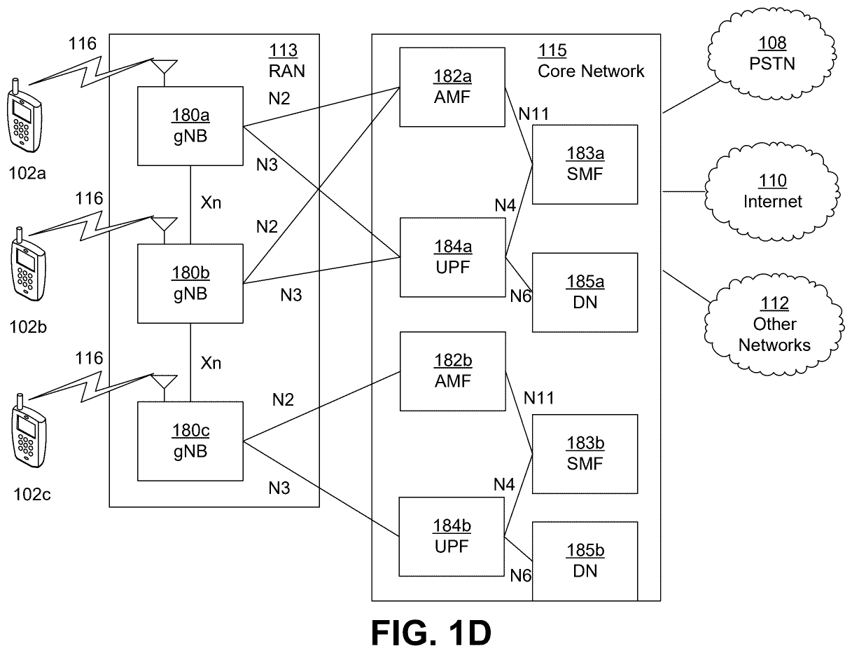

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

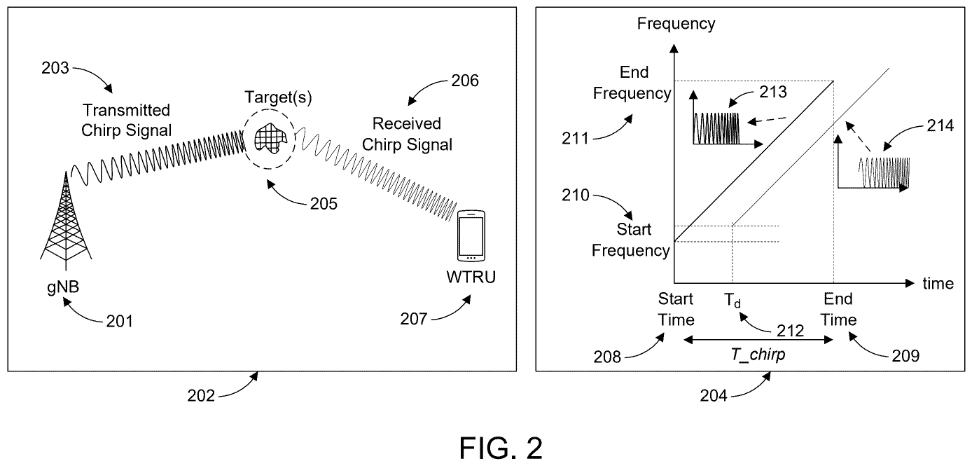

In view of the descriptions provided in connection with FIGS. 1A-1D, and further in view of the following descriptions provided in connection with FIGS. 2-10, it will be understood that a wireless network may include any suitable components and devices, including, for example, any of one or more base stations, one or more TRPs, one or more gNBs, one or more WTRUs, any other suitable device or component, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Overview

In accordance with some embodiments of this disclosure, background information for detecting and reporting a mismatch in the chirp rate is provided as follows. NR employs cyclic prefix orthogonal frequency division modulation (CP-OFDM) for DL and UL, which through transform precoding can become discrete Fourier transform-spread-orthogonal frequency division multiplexing (DFT-s-OFDM) for use in coverage limited scenarios in the UL. OFDM offers high spectral efficiency and robustness against multipath fading channels with flexible time and frequency allocations, which makes it a good candidate waveform for communications. On the other hand, in radar systems, chirp-based waveforms are widely used as they offer multiple advantages that enhance sensing performance, such as higher range resolution, less sensitivity to doppler shifts, and adaptability to different sensing tasks. Chirp-based waveforms provide a balance between resolution, bandwidth and power, which makes them suitable for radar applications.

FIG. 2 is an illustrative diagram of a chirp-based signal transmitted by a transmitter (e.g., gNB 180a, 180b, 180c, 201, 701), reflected at a target (e.g., target 205), and received at a receiver (e.g., WTRU 102a, 102b, 102c, 207, 707), as well as the resulting time and frequency differences between the transmitted (e.g., transmitted chirp signal 203) and received signals (e.g., received chirp signal 206), according to some embodiments of this disclosure. As referred to herein, the terms chirp signal, chirp-based signal, and chirp may be used interchangeably. As referred to herein, the terms transmitted chirp signal and configured chirp signal may be used interchangeably. As referred to herein, the terms received chirp signal, measured chirp signal, and effective chirp signal may be used interchangeably. Different types of chirp signals may be used in sensing systems to obtain sensing measurements (e.g., linear chirps, linear frequency modulated (LFM), non-linear chirps, and/or polyphase chirps). FIG. 2 illustrates an LFM-based chirp transmission, wherein a chirp-based signal (e.g., transmitted chirp signal 203) is transmitted by a transmitter (e.g., gNB 180a, 180b, 180c, 201, 701), reflected by a target (e.g., target 205), and received by a receiver (e.g., WTRU 102a, 102b, 102c, 207, 707). The change between the transmitted and received signal is shown in 204, which illustrates the start time 208 and end time 209 of the chirp signals (e.g., transmitted chirp signal 203, transmitted chirp signal 213, received chirp signal 206, received chirp signal 214) in the x-axis, and the start frequency 210 and end frequency 211 of the chirp signals in the y-axis. The time difference between the transmitted and received chirp signals shows the delay (e.g., delay 212) introduced by the reflection of the target, and the frequency shift denotes the shift introduced, for example, by doppler due to the mobility of the signal. A chirp signal is typically characterized by a chirp rate, which may be linear (e.g., frequency changes at a fixed rate over time), or non-linear (e.g., frequencies vary at different rates over time). The chirp rate should be known at the receiver so that it may demodulate the received signal and extract meaningful sensing information. In the case of having a mismatch between the chirp rates of the transmitted signal and the received signals, the sensing performance may degrade or fail completely.

In accordance with some embodiments of this disclosure, a problem statement for detecting and reporting a mismatch in the chirp rate is provided as follows. Chirp-based sensing involves transmitting a signal where the chirp frequency is modulated over time. Without loss of generality, hereinafter the term “chirp rate” refers to any measure of the frequency variation of the chirp signal (e.g., a slope in a linear chirp characterized with a linearly increasing frequency, a nonlinear frequency variation in a nonlinear chirp, a discrete polyphase change, and/or randomized rate).

The receiver needs to know the chirp rate in order to perform sensing measurements. Any mismatch in the chirp rate (e.g., as a result of channel impairments, oscillator inaccuracies, mismatches between the transmitter and receiver frequencies, or any combination thereof), may deteriorate and even break the sensing task. The chirp mismatch may occur as a result of several factors, such as the timing errors in the start and/or end of a chirp, IQ imbalances or 1 dB compression of circuits driving a voltage-controlled oscillator (VCO), quantization error in digital chirps, amplitude-to-phase modulation (AM-PM) and phase-to-amplitude modulation (PM-AM) distortion, phase noise, transmit-receive (Tx-Rx) coupling, or any combination thereof.

For example, the chirp signal may be generated using a digital-to-analog converter (DAC) and VCO, wherein a set of frequencies are iterated in an incremental manner over a specific period of time, which allows for generating a chirp signal with an increasing or decreasing frequency over time. Having some oscillator inaccuracies, or mismatches between the transmitter and receiver frequencies may lead to a mismatch in the chirp rate. Similarly, when a set of frequencies is used for chirp transmission in high mobility scenarios, these frequencies may shift due to Doppler effect, which directly affects the achievable chirp rate.

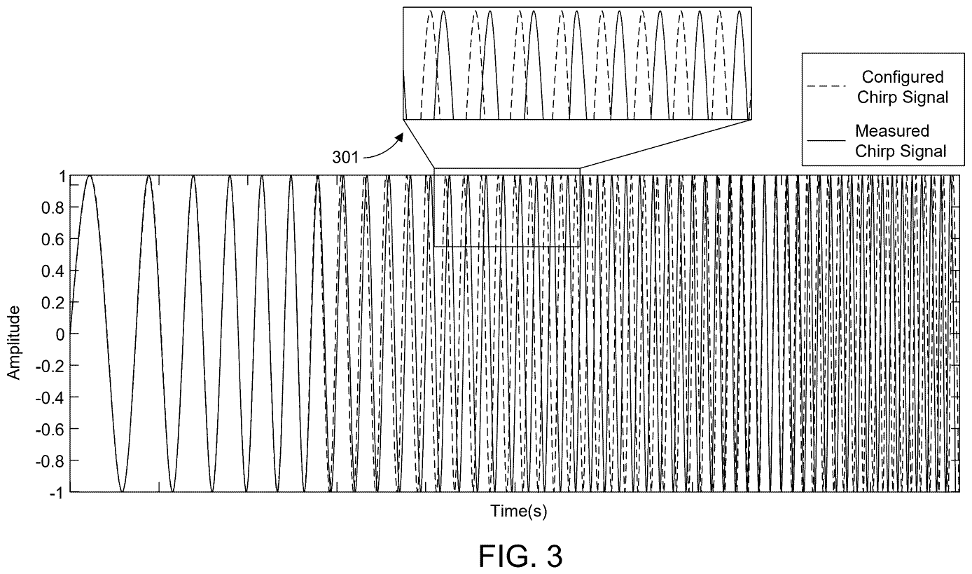

FIG. 3 is an illustrative diagram of an example chirp rate mismatch, according to some embodiments of this disclosure, wherein the configured chirp rate and the measured chirp rate (e.g., measured by a receiver (e.g., WTRU 102a, 102b, 102c, 207, 707)) do not coincide (e.g., due to a mismatch between the configured chirp rate and the measured chirp rate). As illustrated in the enlarged region 301, the measured chirp signal has a smaller frequency than the configured chirp signal. This difference in frequency between the measured chirp signal and the configured chirp signal may be caused by, for example, the target (e.g., target 205) moving away from the receiver (e.g., WTRU 102a, 102b, 102c, 207, 707).

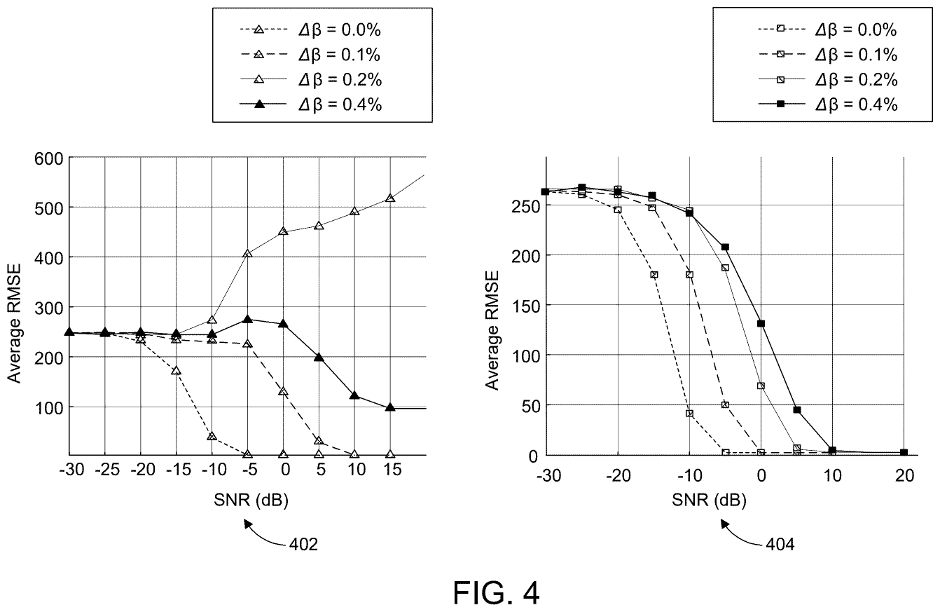

FIG. 4 is an illustrative diagram of an estimated range RMSE for a chirp signal and a chirp signal multiplexed with OFDM, according to some embodiments of this disclosure. Plot 402 shows the RMSE of range estimation (e.g., the difference between estimated range and the actual range) when there is a chirp rate mismatch in chirp rate in a chirp-only sensing system. Plot 404 shows the RMSE of range in an OFDM multiplexed with chirp sensing system, wherein both systems have a mismatch in the chirp rate of Δβ=0.1%, 0.2% and 0.4%. Given that β is the chirp rate, Δβ is the chirp rate mismatch between the configured and determined chirp rate at the receiver, and B (1+Δβ) is the effective chirp rate. FIG. 4 shows a degradation in the RMSE of range estimation when there is a mismatch in the chirp rate. In some cases, the mismatch may be completely destructive to the sensing task, as the case shown in plot 402 when Δβ=0.2%.

Hereinafter, the term “effective chirp rate” or “measured chirp rate” refers to the chirp rate measured by the receiver that may or may not be the same as the configured chirp rate (e.g., due to hardware imperfections and/or channel mobility), thus leading to a chirp rate mismatch. As referred to herein, the terms effective chirp rate, measured chirp rate, and received chirp rate may be used interchangeably. As referred to herein, the terms configured chirp rate and transmitted chirp rate may be used interchangeably.

Hereinafter, the term “calibration” refers to the process of performing the chirp measurements and determining that there is mismatch between the configured chirp information (e.g., configured chirp rate) and the measured chirp information (e.g., measured chirp rate). After calibration, the WTRU may proceed with using the measured chirp information to perform measurements. As referred to herein, the terms configured chirp information and transmitted chirp information may be used interchangeably. As referred to herein, the terms measured chirp information, effective chirp information, and received chirp information may be used interchangeably.

Hereinafter, the term “de-chirping” refers to the process of applying, to the receiver (e.g., WTRU 102a, 102b, 102c, 207, 707), the inverse operation of the chirp applied at the transmitter (e.g., gNB 180a, 180b, 180c, 201, 701).

In accordance with some embodiments of this disclosure, methods and systems for detecting and reporting a mismatch in the chirp rate are provided as follows. In some embodiments, the mismatch in the chirp rate is between a configured chirp rate and an effective chirp rate. Chirp modulation may be incorporated into the sensing transmitted signal (e.g., a chirp-based waveform, a waveform multiplexed with a chirp such as OFDM), wherein a set of chirp-specific measurements are defined (e.g., an effective chirp rate). The receiver may be configured to perform measurements related to the effective chirp rate and indicate mismatches through reporting mechanisms.

In some embodiments, a WTRU (e.g., WTRU 102a, 102b, 102c, 207, 707) receives a control message that includes a configuration for sensing. The control message may include a chirp configuration. The chirp configuration may include chirp information (e.g., chirp rate, chirp frequencies, chirp duration, chirp bandwidth, chirp frequencies, chirp start and end times, or any combination thereof). The chirp configuration may include measurements to be performed. The measurements to be performed may include chirp-rate specific measurements to be performed (e.g., chirp frequencies, chirp start and end times, start and end times of each of frequency, effective chirp rates, chirp effective rate to chirp rate ratios, chirp linearity, or any combination thereof). The chirp configuration may include effective chirp rate specific configurations. The effective chirp rate specific configurations may include chirp rate sets (e.g., expressed as a list of values or an index to a pre-configured table). The effective chirp rate specific configurations may include error groups (e.g., chirp rate deviation error groups). The control message may include triggers to start and terminate the effective chirp matching procedure. The triggers to start and terminate the effective chirp matching procedure may include a mismatch between the measured chirp and configured chirp being above or below a threshold. The triggers to start and terminate the effective chirp matching procedure may include a chirp effective rate to chirp rate ratio being above or below a threshold. The triggers to start and terminate the effective chirp matching procedure may include an effective chirp rate error belonging to a specific error group (e.g., the chirp rate shift error is detected in a specific group). The control message may include an indication that triggers may be impacting measurements, sensing configurations, or any combination thereof. The control message may include an indication that triggers may be impacting reporting of sensing measurements (e.g., performing chirp-based sensing and/or RS sensing).

In some embodiments, the WTRU performs measurements using the received RS(s) (e.g., for a specific period which may be a configuration aspect of the WTRU). The measurements may include an estimation of the effective chirp rate using the received signal(s) (e.g., cross-correlation, matched filters, time-frequency analysis of the received signal (e.g., short-time Fourier transform (STFT), fractional Fourier transform (FRFT)), or any combination thereof). The measurements may include sensing measurements.

In some embodiments, the WTRU processes and/or monitors event triggers of the effective chirp rate procedure. The processing and/or monitoring of event triggers may be based on a measured chirp information mismatch with the configured chirp information. The processing and/or monitoring of event triggers may be based on triggers for effective chirp rate matching. The processing and/or monitoring of event triggers may be based on a mismatch between the configured chirp and the measured chirp.

In some embodiments, the WTRU performs one or more actions based on the estimation output. The actions may include the WTRU calibrating the receiver's chirp rate to match the effective chirp rate. The actions may include the WTRU performing de-chirping to the received chirp-RS (e.g., using chirp configuration and/or using measured chirp information). The actions may include the WTRU verifying reliability of the measurements. The actions may include the WTRU indicating to the network at least one of the triggering event (e.g., sensing accuracy going below a threshold), a chirp rate mismatch, a chirp measurement mismatch, measured chirp information, a chirp rate error group, calibration information, a recommendation for another chirp configuration. The actions may include the WTRU repeating these actions until a triggering condition to terminate the effective chirp matching procedure is satisfied.

In some embodiments, the WTRU performs sensing measurements (e.g., using the calibrated chirp rates).

In some embodiments, the WTRU sends to the network (NW) a sensing measurements report. The sensing measurements report may include chirp measured information (e.g., an effective chirp rate, a chirp rate error group, chirp frequencies, measured chirp start and end times, or any combination thereof). The sensing measurements report may include an indication of a chirp rate mismatch. The sensing measurements report may include an indication of calibration. The sensing measurements report may include post-calibration measurements. The sensing measurements report may include a recommendation for a chirp configuration update.

In accordance with some embodiments of this disclosure, WTRU capability information is provided as follows. A WTRU (e.g., WTRU 102a, 102b, 102c, 207, 707) may receive and decode a first network request (e.g., received through radio resource control (RRC) signaling) to provide WTRU capability information. The WTRU may receive and decode this first network request following the random-access procedure. The WTRU may prepare a capability information message including information related to sensing capabilities (e.g., maximum supported chirp rate, de-chirping methods, calibration methods, chirp measurement methods, or any combination thereof). The information contained in the WTRU capabilities message may include sensing processing capabilities (e.g., inverse frequency transform capabilities and/or maximum number of samples), sensing frequency ranges, sensing bandwidth, sensing modes (e.g., monostatic, bistatic), sensing priorities, sensing spatial resolution, sensing time resolution, support of angle of arrival (AoA) determination and related angular resolution, sensing doppler resolution, reflectivity sensitivity (i.e., the minimum power, signal-to-noise ratio (SNR), absolute amplitude) for the reflections to be detectable by the WTRU, support of carrier phase measurements and related phase resolution, support of half-duplex or full-duplex for monostatic sensing, related parameters (e.g., frequency range and/or maximum allowed transmit power for sensing), or any combination thereof. The WTRU may send the WTRU capability information message through RRC signaling (e.g., over physical uplink shared channel (PUSCH)). The WTRU capability information may be then used by the network to optimize its configuration and resource allocation for sensing.

In accordance with some embodiments of this disclosure, RS configurations are provided as follows. A WTRU (e.g., WTRU 102a, 102b, 102c, 207, 707) may receive configuration on the RS, for downlink RS, uplink RS, or both. The configuration on the RS may include an ID (index), a number of resources, resource sets, a resource set ID, a sequence ID, a periodicity, a type, a repetition factor, a comb pattern, a comb size, a spatial relation for transmission, a spatial relation for reception, quasi colocation (QCL) information, subcarrier spacing, an ID, a number of spatial layers, a start and/or end time for transmission, a time window, power related information, beam related information, or any combination thereof. Examples of DL RS are channel state information reference signal (CSI-RS), phase tracking reference signal (PTRS), positioning reference signal (PRS), tracking reference signal (TRS), synchronization signal block (SSB), and dedicated sensing RS. Examples of UL RS are sounding reference signal (SRS), sounding reference signal for positioning (SRSp), and dedicated sensing RS.

In accordance with some embodiments of this disclosure, chirp configurations are provided as follows. In some embodiments, the WTRU receives a chirp configuration. The chirp configuration may include chirp information (e.g., chirp rate, chirp duration, chirp bandwidth, chirp frequencies, chirp frequencies start and end time, chirp start and end time, or any combination thereof). The chirp configuration may include chirp multiplexing configurations (e.g., periodicity, repetition factor, time and frequency resources (e.g., time-division duplexing (TDD), frequency-division duplexing (FDD)), or any combination thereof). The chirp configuration may include chirp-based RS information (e.g., chirp-only RS, chirp multiplexed RS (e.g., an RS multiplexed with a chirp), or any combination thereof). The chirp configuration may include configurations in terms of time, frequency, power, and beamforming for chirp transmissions in the UL. The chirp configuration may include chirp design aspects such as ambiguity function, autocorrelation function, delay and/or doppler resolution, or any combination thereof.

In accordance with some embodiments of this disclosure, measurement configurations are provided as follows. The WTRU (e.g., WTRU 102a, 102b, 102c, 207, 707) may receive a configuration from the network (e.g., via RRC signaling) that may include an indication from the network to start a sensing task that is related to a sensing target (e.g., target localization, tracking). The configuration may include chirp sensing measurements with its corresponding measurement time window and triggers that may include a sensing task configuration, reference signal information and/or DL reference signal configuration, metrics to be used for the target sensing task measurement, thresholds for effective chirp rate match reporting, report update and termination, reporting configuration, or any combination thereof.

The sensing task configuration may include an indication such as a flag to activate or deactivate the chirp sensing measurements, a time window for the chirp sensing measurement procedure (e.g., start time, a minimum and/or maximum duration, a number of measurement occasions for update and termination, or any combination thereof).

The sensing task configuration may include triggers for initiating or terminating the chirp sensing measurement procedure. The triggers for initiating or terminating the chirp sensing measurement procedure may include chirp-based triggers (e.g., based on the chirp effective rate to chirp rate ratio going above or below a threshold, based on the effective chirp rate error belonging to a specific error group, or any combination thereof). The triggers for initiating or terminating the chirp sensing measurement procedure may include time-based triggers (e.g., the WTRU initiating or terminating a chirp sensing measurements at predefined intervals for periodic monitoring). The triggers for initiating or terminating the chirp sensing measurement procedure may include event-based triggers (e.g., the WTRU initiating or terminating chirp sensing measurements in response to signal parameters such as signal-to-interference-plus-noise ratio (SINR) falling below configured thresholds). The triggers for initiating or terminating the chirp sensing measurement procedure may include location-based triggers (e.g., when the WTRU enters or leaves a geographical area and/or when the WTRU detects a proximity to a particular target or location being above or below a proximity threshold). The WTRU may be triggered to initiate or terminate chirp sensing measurement if the measured WTRU location (e.g., using radio access technology (RAT)-dependent and/or independent methods) and the configured target location are separated by a distance that is below a threshold. The triggers for initiating or terminating the chirp sensing measurement procedure may include mobility-based triggers (e.g., accounting for the WTRU being stationary or mobile). The WTRU may be triggered to activate or deactivate chirp sensing measurements if the measured WTRU velocity is above a threshold value and/or within a range of threshold values. The WTRU may be triggered to activate or deactivate chirp sensing measurements if the difference between the measured WTRU velocity and the configured target velocity is below a threshold value. The triggers for initiating or terminating the chirp sensing measurement procedure may include quality of service (QoS)-based triggers (e.g., based on sensing accuracy or resolution, positioning-based QoS (e.g., positioning resolution in meters), reliability-based QoS (e.g., missed detection and false alarm percentages), communication performance or accuracy, or any combination thereof).

The sensing task configuration may include chirp sensing task measurement reporting information. The chirp sensing task measurement reporting information may include a reporting type (e.g., periodic, semi-periodic, aperiodic), reporting measured chirp information (e.g., absolute chirp measurements, and/or relative chirp measurements with respect to the configured chirp), reporting thresholds (e.g., conditions for the WTRU to report chirp sensing measurement information based on changes in the sensing measurements or other predefined criteria), reporting content and format (e.g., raw versus processed data, statistical or instantaneous data), or any combination thereof. The reporting content may be based on the chirp sensing measurements (e.g., chirp rate match or mismatch, effective chirp rate, or any combination thereof). The reporting content may contain chirp based and non-chirp based sensing measurements. The chirp sensing task measurement reporting information may include a timing reporting granularity factor. The timing reporting granularity factor may be configured based on the chirp sensing measurement configuration (e.g., chirp bandwidth, chirp start and end time, chirp frequencies start and end time, or any combination thereof). The timing reporting granularity may be configured based on measured RS metrics (e.g., reference signal received power (RSRP), reference signal received path power (RSRPP), channel impulse responses (CIR), SINR, reference signal received quality (RSRQ), or any combination thereof). The chirp sensing task measurement reporting information may include reporting resources (e.g., uplink resources such as transmission power, resource blocks, and/or scheduling information). The chirp sensing task measurement reporting information may include error handling and sensing strategies.

The configuration may include reference signal information and/or DL reference signal configuration. The reference signal information and/or DL reference signal configuration may include reference signal types (e.g., chirp only RS, PRS), resource sets, time and/or frequency characteristics such as pattern and density, cover codes, periodicity, time gap, and comb size, power settings, beamforming and/or precoding related information (e.g., beam IDs, transmission configuration indicator (TCI) settings, QCL information, or any combination thereof).

The configuration may include metrics to be used for the target sensing task measurement (e.g., in relation to reference signals). The metrics to be used for the target sensing task measurement may include RSRP, RSRPP, RSRQ, SINR, channel quality indicator (CQI), rank indicator (RI), precoding matrix indicator (PMI), timing advance (TA), micro-Doppler frequency, or any combination thereof.

The configuration may include thresholds for effective chirp rate match reporting, report updating, and termination (e.g., static threshold to determine the detection effective chirp rate match). The static threshold to determine the detection effective chirp rate match may include a chirp frequencies mismatch threshold (e.g., mismatch of at least one measured chirp frequency with respect to a corresponding configured frequency going above or below a threshold), a chirp effective rate to chirp rate ratio, the effective chirp rate error belonging to a specific error group (e.g., the chirp rate shift error is detected in a specific group), a communication performance (e.g., bit error rate (BER)) going below a specific threshold, or any combination thereof. The thresholds for effective chirp rate match reporting, report updating, and termination may include measurement accuracy thresholds, update thresholds, and/or termination thresholds.

The configuration may include reporting configuration. The reporting configuration may include allocated reporting uplink control and/or data channels. The allocated reporting uplink control and/or data channels may include a number of allocated resources (e.g., a number of uplink resources and/or number of downlink resources), a type of allocated resources, a type of allocation (e.g., uplink channel x is allocated to report y, uplink channel x is allocated to periodic reporting, uplink channel x is allocated to report on event y). The reporting configuration may include a periodicity of reporting information. The periodicity of reporting information may include a type (e.g., periodic, aperiodic, semipersistent), a period time between two successive reports (e.g., periodic, semipersistent), report types associated to each periodicity type (e.g., report x is periodic, report y is semipersistent). The reporting configuration may include report content. The report content may include events detected (e.g., effective chirp rate match or mismatch detection), chirp measurements (e.g., effective chirp rate detected), RS measurements (e.g., RSRP, RSRPP, received signal code power (RSCP)), or any combination thereof.

In accordance with some embodiments of this disclosure, sensing measurements are provided as follows. The WTRU (e.g., WTRU 102a, 102b, 102c, 207, 707) may receive a set of reference signals to perform measurements for sensing (e.g., PRS, CSI-RS, SSB, demodulation reference signal (DMRS), or any combination thereof). The received reference signals may be configured to include chirp or to not include chirp. The WTRU may be configured to perform a set of measurements using a first set of RS(s) (e.g., without chirp). These measurements may be performed in an allocated time window indicated to the WTRU by the network, wherein the time window configuration may include the relevant information about the start and end measurement times (e.g., in frames, slots, symbol index, absolute time, and/or relative time), duration (e.g., in number of frames, slots, symbols, and/or seconds), periodicity (e.g., in number of frames, slots, symbols, and/or seconds), or any combination thereof. The WTRU may be configured to perform a set of measurements using a second set of chirp-based RS(s) (e.g., with chirp). These measurements may be performed in a second allocated time window indicated to the WTRU by the network, wherein the time window configuration includes relevant information about the start and end measurement times. The WTRU may be configured by the network to measure at least one of the time of arrival (ToA), reference signal time difference (RSTD), AoA, absolute or relative RSRPP, RSCP, doppler spectrum, micro-doppler (MD), or rich communication service (RCS) with the associated time from the resources, using the first set of RS(s) or the second set of RS(s).

In some embodiments, the WTRU is configured by the network to perform a set of sensing measurements using the first set of RS(s) or the second set of RS(s) (e.g., from one or more antenna ports, from a single or multiple transmission and reception points (TRPs), or any combination thereof). The WTRU may obtain time-based measurements (e.g., time difference of arrival (TDoA) and/or ToA), power-based measurements (e.g., RSRP, RSRPP, RCS, and/or peak-to-sidelobe), phase-based measurements (e.g., AoA and/or doppler), or any combination thereof.

In some embodiments, the WTRU uses the chirp information provided in the configuration (e.g., for the second set of measurements) to obtain the range estimation (e.g., using the difference between the configured and the received chirp signal (e.g. beat frequency)), the radial velocity (e.g., using the measured phase difference between multiple chirp-based RS(s)), the overall doppler shift, the angles (e.g., AoA), micro-doppler estimation, RCS, or any combination thereof.

In some embodiments, the WTRU receives the first set of RS(s) or the second set of RS(s) from one or multiple configured antenna ports for sensing (e.g., from a single TRP and/or multiple TRPs). The WTRU may perform multiple measurements (e.g., pre-configured measurements) of the channel responses. The WTRU may perform relative measurements of the channel responses with respect to first path directed towards the WTRU.

The WTRU may obtain the channel frequency responses (CFR) at the configured RS resources (e.g., by performing interpolation between consecutive resource elements over the desired frequency region). The WTRU may obtain the CIR and packet data protocol (PDP) (e.g., by performing inverse frequency transformations) to the obtained frequency responses. The PDPs may be obtained by determining the power values of CIR (e.g., by determining the absolute square values). The WTRU may select the set of responses (e.g., CIR and/or PDP) that are above a minimum configured threshold (e.g., SNR threshold and/or RSRP thresholds). The WTRU may select and keep the set of responses (e.g., CIR and/or PDP) received within the preconfigured time window. The WTRU may keep the set of time differences between the obtained set of responses (e.g., CIR and/or PDP) within the preconfigured time window. The WTRU may determine the set of measurement accuracies and certainties (e.g., RMSE of range estimation, RMSE of velocity estimation, uncertainty of a channel measurement (e.g., AoA, TDoA, CIR, doppler, and/or RCS), or any combination thereof).

In accordance with some embodiments of this disclosure, chirp measurements are provided as follows. The WTRU (e.g., WTRU 102a, 102b, 102c, 207, 707) may receive the set of reference signals with chirp to perform chirp measurements (e.g., dedicated chirp signal, an RS multiplexed with chirp (e.g., OFDM multiplexed with chirp), PRS, CSI-RS, SSB, DMRS, or any combination thereof).

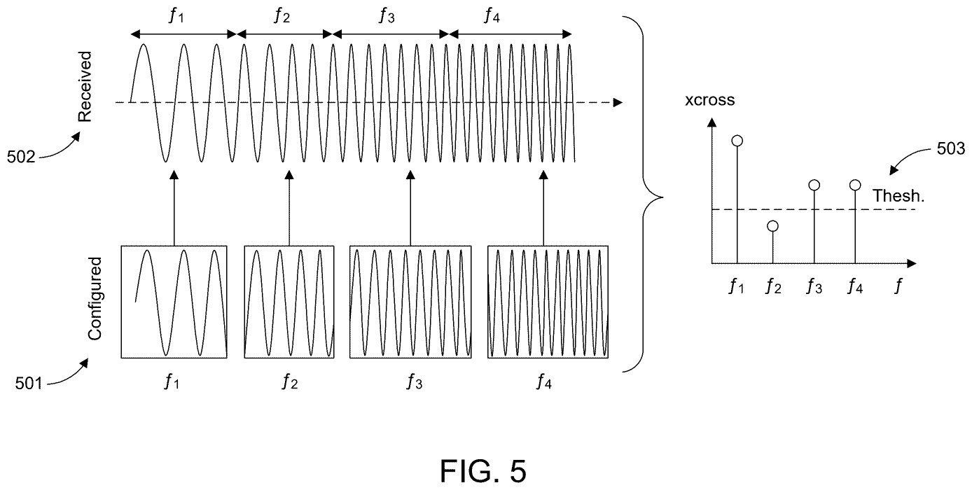

FIG. 5 is an illustrative diagram of a set of preconfigured chirp frequencies (e.g., configured chirp frequencies 501) correlated with the received chirp-based signal frequencies (e.g., received chirp frequencies 502) and the correlation level with respect to a threshold (e.g., correlation threshold 503), according to some embodiments of this disclosure. FIG. 5 exemplifies that the correlation level obtained for each configured frequency may be compared to a preconfigured correlation level (e.g., correlation threshold 503).

In some embodiments, the WTRU receives a set of chirp information as part of the RS configuration. The set of chirp information may include a chirp set of operating N_{chirp} frequencies (e.g., f₁, f₂, . . . , f_{N}_{_{chirp}}), which may be received in Hertz (Hz), number of resource elements (REs), number of resource blocks (RBs), number of symbols, or any combination thereof. The set of chirp information may include the subset of frequencies to be used for sensing (e.g., set of frequencies of the available N_{chirp} frequencies, which may be received in Hz, number of REs, number of RBs, number of symbols, or any combination thereof). The set of chirp information may include a bandwidth (e.g., in Hz, number of REs, number of RBs, and/or number of symbols). The set of chirp information may include a subset of the chirp bandwidth (e.g., a portion of the reported chirp bandwidth). The set of chirp information may include the chirp rate (e.g., the rate of change between two frequencies in the set of N_{chirp} frequencies). The set of chirp information may include the chirp time information (e.g., in terms of symbols, slots, frames, subframes, and/or seconds). The set of chirp information may include the chirp start and end time, which may include the start and end time of a chirp signal, start and end time of a single frequency (e.g., fᵢ) in a chirp, or the start and end time of multiple frequencies within the chirp (e.g., fᵢ, . . . , fᵢ₊ⱼ), in terms of symbols, slots, frames, subframes, seconds). The set of chirp information may include the chirp phase information (e.g., set of different phases). The set of chirp information may include the chirp amplitude information (e.g., set of different magnitudes of the chirp signal). The set of chirp information may include the chirp frequencies mismatch of oscillators (e.g., obtained from the synchronization process, carrier frequency offset (CFO), the applied adaptive correction with Phase-Locked Loop (PLL) and/or Digital Frequency Locked Loop (DFLL)).

In some embodiments, the WTRU receives additional positioning information from the network upon request (e.g., from the WTRU, or semi-statically (e.g., via RRC)). The additional positioning information may include parameters to aid in performing chirp-mismatch measurements and/or sensing measurements. The additional positioning information may include WTRU coordinates (e.g., absolute coordinates and/or relative coordinates with respect to the TRP), WTRU mobility information (e.g., absolute velocity and/or relative velocity with respect to the TRP), gNB and/or TRP coordinates (e.g., absolute coordinates and/or relative coordinates with respect to the WTRU), gNB and/or TRP mobility information (e.g., absolute velocity and/or relative velocity with respect to the WTRU), or any combination thereof.

In some embodiments, the WTRU performs a set of measurements on the received chirp-based signal (e.g., a single RS and/or multiple RSs) in order to detect the chirp rate mismatch. The set of measurements on the received chirp-based signal may include the WTRU obtaining the correlation information between the received chirp-based signals (e.g., set of RSs). The set of measurements on the received chirp-based signal may include the WTRU performing cross-correlation between the received chirp-based signals and the set of preconfigured frequencies (e.g., configured frequencies 501). The correlation level obtained for each configured frequency may be compared to a preconfigured correlation level (e.g., correlation threshold 503), as exemplified in FIG. 5. The set of measurements on the received chirp-based signal may include the WTRU using a matched filter or set of match filters to estimate the chirp rate of the received signal. The set of measurements on the received chirp-based signal may include the WTRU obtaining the level of uncertainty of the estimated chirp rate with respect to a threshold. The set of measurements on the received chirp-based signal may include the WTRU applying time-frequency analysis on the set of resources with the chirp-based signals to measure the received set of chirp frequencies (e.g., \hat{f}₁, \hat{f}₂, . . . , \hat{f}_{N}_{_{chirp}}) as well as the effective chirp rate. The WTRU may use STFT, FRFT, Wigner transform, Gabor transform, or any combination thereof to obtain the instantaneous frequencies of the received signal as well as the effective chirp rate (e.g., received chirp signal's chirp rate). The set of measurements on the received chirp-based signal may include the WTRU obtaining the start and end time of the chirp signal (e.g., the WTRU detects the start time Tₛₜₐᵣₜ and end time T_{chirp} of the chirp frequencies sweep over the preconfigured resources of the chirp-based signal). The set of measurements on the received chirp-based signal may include the WTRU obtaining the start and end time of each frequency (e.g., the WTRU detects the start time and end time of each of the chirp frequencies (e.g., \hat{t}ᵢ, \hat{t}ᵢ₊₁). The set of measurements on the received chirp-based signal may include the WTRU obtaining the beat frequency (e.g., the difference between the transmitted frequency and receiver frequency). The set of measurements on the received chirp-based signal may include the WTRU obtaining the doppler shift of the received signal (e.g., using the sensing doppler measurements).

In accordance with some embodiments of this disclosure, chirp mismatch measurements are provided as follows. The WTRU (e.g., WTRU 102a, 102b, 102c, 207, 707) may use the chirp rate measurements to obtain the chirp rate mismatch between the received chirp-based signal over the configured resources (e.g., set of RSs). The WTRU may obtain the difference between the configure chirp rate and measured chirp rate (e.g., using the obtained set of detected frequencies of the received chirp-based signal over the configured resources). The WTRU may obtain the difference between the configured set of chirp frequencies and the measured chirp frequencies. The WTRU may obtain the correlation measurements (e.g., f_{1_corr}, f_{2_corr}, . . . , f_{N}_{_{chirp_corr}}) between the measured frequencies (e.g., \hat{f}₁, \hat{f}₂, . . . >\hat{f}_{N}_{_{chirp_corr}}) and the configured chirp frequencies (e.g., f₁, f₂, . . . f_{N}_{_{chirp}}). The WTRU may obtain the difference between the start and end time of the configured chirp and received chirp. The WTRU may obtain the difference between the start and end time of at least a single frequency of the configured chirp and its corresponding start and end time in the received chirp. The WTRU may obtain the information at the output of the matched filters applied to the chirp-based signal over the preconfigured resources, which may include the output peaks of the matched filters (e.g., at the expected time of arrival), the modulated response of the matched filters (e.g., the alignment of the set of frequencies at the output of the matched filters with respect to a preconfigured threshold), the delay information of the output of the matched filters (e.g., the peaks at the expected delay), or any combination thereof. The WTRU may observe if the set of frequencies detected (e.g., using STFT) aligns with the set of preconfigured chirp frequencies. The WTRU may observe the beat frequency with respect to a preconfigured threshold (e.g., a threshold corresponding to an a-priori known object's location). The WTRU may associate the chirp-rate mismatch measurements with obtained set of sensing measurements (e.g., with the peaks of channel responses and/or with the target sensing measurements). The WTRU may receive chirp linearity (e.g., in case of using a linear chirp).

The WTRU may use the chirp rate mismatch measurements to determine the effective chirp rate (e.g., the measured chirp rate). The WTRU may use the set of measured frequencies (e.g., \hat{f}₁, \hat{f}₂, . . . \hat{f}_{N}_{_{chirp}}), as well as the start and end time of the chirp to obtain the effective chirp rate as:

$$\hat{k} = \frac{Δ f}{Δ T} = \frac{{\hat{f}}_{{N}_{chirp}} - {\hat{f}}_{1}}{{T}_{chirp} - {T}_{start}} .$$

In some embodiments, the WTRU uses the set of measured frequencies (e.g., \hat{f}₁, \hat{f}₂, . . . , \hat{f}_{N}_{_{chirp}}), or a subset of the measured frequencies, as well as the start and end time of each of the measured chirp frequency to obtain the instantaneous effective chirp rate as:

$${\hat{k}}_{i} = \frac{{\hat{f}}_{i + 1} - {\hat{f}}_{i}}{{t}_{i + 1} - {t}_{i}} .$$

In some embodiments, the average effective chirp rate is obtained as:

$$\overline{k} = \frac{1}{{N}_{chirp} - 1} {\sum }_{i}^{{N}_{Chirp} - 1} {k}_{i} .$$

In some embodiments, the WTRU determines the set of differences between the set of measured chirp properties. The WTRU may obtain the difference between the measured chirp frequencies, \hat{f}₁, \hat{f}₂, . . . , \hat{f}_{N}_{_{chirp}}, and configured chirp frequencies, \hat{f}₁, \hat{f}₂, . . . , \hat{f}_{N}_{_{chirp}}, as:

$$Δ {f}_{{N}_{chirp}} = {\sum }_{i}^{{N}_{Chirp}} \vert {\hat{f}}_{i} - {f}_{i} \vert .$$

The WTRU may obtain the percentage of the difference between the measured set of frequencies and the configured frequencies as:

$$ρ = \frac{Δ {f}_{{N}_{chirp}}}{BW} \times 100.$$

In some embodiments, the WTRU determines a value that denotes the mismatch level. The WTRU may use the correlation levels between the measured chirp frequencies and the preconfigured chirp frequencies to obtain the level of mismatch (e.g., average R_{f,\hat{f}}=ΣR_{f}_{ᵢ}_{,\hat{f}}ᵢ), or the instantaneous correlation, R_{f}_{ᵢ}_{,\hat{f}}ᵢ, of the i^{th} chirp frequency.

In some embodiments, the WTRU determines the error group of the mismatch based on the chirp mismatch measurements. The error groups may define the level of chirp rate mismatch detected, which may be divided into multiple groups (e.g., low, high, multiple levels, error_group_1, error_group_2), which may be obtained based on chirp rates, correlations, matched-filters, frequency-time analysis (e.g., using STFT), or any combination thereof. Obtaining the error groups may be based on the chirp-rate mismatch being above or below a specific threshold, or outside of a range, over a configured measurement window, the mismatch error falling into a specific error group, or any combination thereof. Obtaining the error groups may be based on the correlation level between the measured and configured set of chirp frequencies being above or below a specific threshold, or outside of a range, over a configured measurement window, the mismatch error falling within a specific uncertainty level, or any combination thereof. Obtaining the error groups may be based on the peak level at the output of the matched being above or below a specific threshold, or outside of a range, over a configured measurement window, the mismatch error falling within a specific uncertainty level, or any combination thereof. Obtaining the error groups may be based on the alignment between the set of configured and measured frequencies being above or below a specific threshold, or outside of a range, over a configured measurement window, the mismatch error falling within a specific uncertainty level, or any combination thereof. Obtaining the error groups may be based on the difference between the set of configured and measured chirp frequencies being above or below a specific threshold, or outside of a range, over a configured measurement window, the mismatch error falling within a specific uncertainty level, or any combination thereof. Obtaining the error groups may be based on the difference between the configured and measured set of start and end times being above or below a specific threshold, or outside of a range, over a configured measurement window, the mismatch error falling within a specific uncertainty level, or any combination thereof.

In some embodiments, the WTRU observes the doppler measurements and the mobility information (e.g., assistance information received by the TRP) of the receiver (e.g., 102a, 102b, 102c, 207, 707) and/or transmitter (e.g., TRP) in order to compensate for the doppler shift introduced by the transmitter and/or receiver mobility. The total doppler shift of the received signal may consist of the doppler shift introduced by the receiver's mobility

$$( e . g . , {f}_{D}^{Rx} ) ,$$

The doppler shift introduced by the target's mobility

$$( e . g . , {f}_{D}^{Tr} ) ,$$

the doppler shift introduced by the transmitter's mobility

$$( e . g . , {f}_{D}^{Tx} ) ,$$

or any combination thereof.

In some embodiments, the WTRU estimates the doppler shift introduced by the receiver's mobility as:

$${f}_{D}^{Rx} \approx \frac{{f}_{c}}{c} ( {v}_{Rx} \cdot {r}_{1} ) ,$$

wherein vᵣₓ denotes the velocity vector of the transmitter in x, y and z direction, and r₂ denotes the direction vector.

In some embodiments, the WTRU determines the combined doppler shift of the transmitter and receiver as:

$${f}_{D}^{Tx , Rx} = ( {f}_{D}^{Rx} + {f}_{D}^{Tx} ) .$$

The doppler shift introduced by the target's mobility may be extracted using the sensing measurements, or may be estimated by extracting it from the overall doppler shift, for example,

$${f}_{D}^{Tr} \approx {f}_{D} - {f}_{D}^{Tx , Rx} .$$

In some embodiments, the WTRU uses the chirp rate mismatch measurements in order to determine the calibration information, which may include the measured set of frequencies (e.g., \hat{f}₁, \hat{f}₂, . . . , \hat{f}_{N}_{_{chirp}}), the measured start and end time of the chirp signal, the measured start and end time of a set of frequencies within a chirp signal, the measured start and end time of a single frequency within a chirp signal, the measured affective chirp rate, or set of chirp rates, the measured set of chirp rates detected over a set of frequencies, the measured of chirp rates detected in a time window, or any combination thereof.

In some embodiments, the WTRU uses the calibration information to perform another set of sensing measurements (e.g., by replacing the configured chirp information with measured chirp information). The WTRU may determine, using the measured chirp information, the range estimation (e.g., using the difference between the configured and the received chirp signal (e.g., beat frequency)), the radial velocity (e.g., using the measured phase difference between chirp-based RS(s)), the overall doppler shift, the angles (e.g., AoA), micro-doppler estimation, RCS, or any combination thereof.

In accordance with some embodiments of this disclosure, chirp rate mismatch triggers are provided as follows. Conditions for triggering, starting or terminating the reporting of chirp rate mismatch may comprise triggering conditions for reporting of chirp rate mismatch, and/or triggering conditions to terminate the reporting of chirp rate mismatch.

Triggering conditions for reporting of chirp rate mismatch may comprise chirp-based triggering conditions, time-based triggering conditions, event-based triggering conditions, location-based triggering conditions, mobility-based triggering conditions, or any combination thereof.

Chirp-based triggering conditions may comprise the ratio of effective chirp rate to configured chirp rate, or the difference between the effective chirp rate and the configured chirp rate, being above or below a specific threshold, or outside a range, over a configured measurement window, the effective chirp rate error belonging to a specific error group over a configured measurement window, the difference between the set of configured and measured chirp frequencies being above or below a specific threshold, or outside a range, over a configured measurement window, the difference between the configured and measured set of start and end times being above or below a specific threshold, or outside a range, over a configured measurement window, or any combination thereof.

Time-based triggering conditions may comprise a time elapsed since a given reference instant being equal to or greater than a threshold, a time elapsed since the last reporting instant exceeding an absolute or relative duration (e.g., a configured periodicity), or any combination thereof.

Event-based triggering conditions may comprise a signal parameter (e.g., a SINR) being lower than a configured threshold, or outside a range, over a configured measurement window, uncertainty in one or more of the positioning and/or sensing metrics (e.g., ToA, AoA, SNR, RSRPP, RSCP, a position, and/or a velocity) of any of the WTRU (e.g., WTRU 102a, 102b, 102c, 207, 707) or sensed targets being above a threshold or set of thresholds for each positioning and/or sensing metric, reliability (e.g., missed detection or false alarm percentages) or communication performance being below a threshold, an explicit indication by the network to report chirp rate mismatch, or any combination thereof.

Location-based triggering conditions may comprise the WTRU entering or leaving a certain geographical area, the WTRU detecting a proximity to a particular target or location, the distance between a WTRU location (e.g., determined using radio access technology (RAT)-dependent and/or independent methods) and the target location being below a threshold, or any combination thereof.

Mobility-based triggering conditions may comprise the measured WTRU velocity being above a threshold value or outside a range of threshold values, the difference between the measured WTRU velocity and the configured target velocity being above a threshold value, the combined doppler shift of the transmitter and receiver exceeding a threshold, or set of thresholds, or being outside a range, over the configured measurement window, a change in one or more of the channel state information (CSI) variation metrics exceeding a threshold, or set of thresholds, or being outside a range, over the configured measurement window, a change in the channel estimation error being above a threshold, a change in the uncertainty of any of the positioning and/or sensing metrics being above a threshold, a change in the channel conditions (e.g., SNR, RSRP, and/or number of MPC components) being above a threshold, or any combination thereof.

Triggering conditions to terminate the reporting of chirp rate mismatch may comprise chirp-based triggering conditions, time-based triggering conditions, event-based triggering conditions, location-based triggering conditions, mobility-based triggering conditions, or any combination thereof.

Chirp-based triggering conditions may comprise the ratio of effective chirp rate to configured chirp rate, or the difference between the effective chirp rate and the configured chirp rate, being within a range over a configured measurement window, the effective chirp rate error not belonging to any error group over a configured measurement window, the difference between the set of configured and measured chirp frequencies being above or below a specific threshold, or outside a range, over a configured measurement window, the difference between the configured and measured set of start and end times being above or below a specific threshold, or outside a range, over a configured measurement window, or any combination thereof.

Time-based triggering conditions may comprise a time elapsed since a given reference instant being equal to or greater than a threshold, and/or a periodicity condition being terminated (e.g., a maximum number of periods), or any combination thereof.

Event-based triggering conditions may comprise a signal parameter (e.g., a SINR) being higher than a configured threshold, or inside a range, over a configured measurement window, uncertainty in one or more of the positioning and/or sensing metrics (e.g., ToA, AoA, SNR, RSRPP, RSCP, a position, and/or a velocity) of any of the WTRU or sensed targets being below a threshold or set of thresholds for each positioning and/or sensing metric, reliability (e.g., missed detection or false alarm percentages) or communication performance being above a threshold, an interference indicator exceeding a specific threshold (e.g., SNR, SINR) in the communications channel going below a specified threshold, an explicit indication by the network to terminate the reporting of chirp rate mismatch, a low-battery indication by the WTRU, or any combination thereof.

Location-based triggering conditions may comprise the WTRU entering or leaving a certain geographical area, the WTRU detecting a distance to a particular target or location that is above a threshold, the distance between a WTRU location (e.g., determined using radio access technology (RAT)-dependent and/or independent methods) and the target location is above a threshold, a change in the location of the WTRU or one or more objects above a threshold (e.g., the WTRU goes out of the preconfigured area of interest), or any combination thereof.

Mobility-based triggering conditions may comprise the measured WTRU velocity being below a threshold value or within a range of threshold values, the difference between the measured WTRU velocity and the configured target velocity being below a threshold value, the combined doppler shift of the transmitter and receiver exceeding a threshold, or set of thresholds, or is outside a range, over the configured measurement window, a change in one or more of the CSI variation metrics being below a threshold, or set of thresholds, or is inside a range, over the configured measurement window, a change in the channel estimation error being below a threshold, a change in the uncertainty of any of the positioning and/or sensing metrics being below a threshold, a change in the channel conditions (e.g., SNR, RSRP, and/or number of MPC components) being below a threshold, or any combination thereof.

In accordance with some embodiments of this disclosure, WTRU behaviors are provided as follows. In some embodiments, the WTRU (e.g., WTRU 102a, 102b, 102c, 207, 707) receives a set of RS(s) without chirp, (e.g., PRS, CSI-RS) and perform a set of measurements on the received and reflected signals. For example, the WTRU may obtain the AoA, ToA, TDoA, RSRP, RSRPP, SNR, doppler, RCS, the sensing measurements associated with target object with uncertainties (e.g., range, velocity, and/or lobes information), channel responses measurements (e.g., CIR, PDP, and/or CFR), or any combination thereof.

In some embodiments, the WTRU receives a set of RS(s) with chirp (e.g., dedicated chirp signal, an RS multiplexed with chirp) and performs a set of measurements on the received and reflected signals. For example, the WTRU may obtain the AoA, ToA, TDoA, RSRP, RSRPP, SNR, doppler, RCS, the sensing measurements associated with target object with uncertainties (e.g., range, velocity, and/or lobes information), the channel responses measurements (e.g., CIR, PDP, and/or CFR), relative measurements (e.g., delta measurements with respect to the first set of measurements (e.g., without chirp)), or any combination thereof.

In some embodiments, the WTRU starts with performing chirp measurements on the received and/or reflected signals (e.g., chirp-based RS(s)). The WTRU may start with performing the chirp measurements. The WTRU may use the chirp measurements and perform calibration to the received signal, then perform another set of sensing measurements (e.g., extract the range and velocity measurements).

In some embodiments, the WTRU performs a set of chirp measurements to obtain chirp mismatch. For example, the WTRU may receive a set of RS(s) that include a chirp signal (e.g., with chirp), the WTRU may use the set of measurements to obtain the chirp signal characteristics (e.g., set of frequencies, start and end time of the chirp signal, start and end time of subset of frequencies, and/or start and end time of a single frequency), the WTRU may obtain the chirp rate of the chirp signal (e.g., a slope in a linear chirp characterized with a linearly increasing frequency, a nonlinear frequency variation in a nonlinear chirp, a discrete polyphase change, and/or randomized rate), the WTRU may determine if the obtained chirp rate is different from the configured chirp rate, the WTRU may determine that at least one of the obtained chirp measurements is different from the configured chirp information, and/or their difference exceeds or goes below or between a specific range, or any combination thereof.

In accordance with some embodiments of this disclosure, methods and systems for calibration of the receiver's chirp rate are provided as follows. If the WTRU (e.g., WTRU 102a, 102b, 102c, 207, 707) determines that the obtained chirp rate is different from the configure chirp rate, or at least one of the chirp measurements mismatches a specific chirp configuration, the WTRU may proceed as follows. The WTRU may use chirp measurements to determine the error group of the mismatch based on the chirp mismatch measurements (e.g., low, high, or multiple levels, error_group_1, error_group_2), which can be obtained as follows. The WTRU may proceed to perform calibration of the chirp mismatch by replacing the receiver's chirp information obtained in the configuration with the measured chirp information (e.g., measured chirp rate, measured set of frequencies, measured start and end time of the chirp, and/or measured start and end time of each of the measured frequencies). The WTRU may perform post-calibration sensing measurements using the calibrated chirp information (e.g., perform range and velocity estimation using the measured chirp information, not the configured chirp information, measured frequencies, and/or measured start and end time of each frequency or all chirp). The WTRU may indicate to the network the chirp measurement mismatch (e.g., effective chirp rate). The WTRU may indicate the set of chirp measurements (e.g., frequencies, start and end time of the chirp, and/or start and end times of a set of frequencies in the chirp). The WTRU may indicate to the network a recommendation for chirp configuration update.

In some embodiments, if the chirp mismatch detection is not reliable or that the determination of the effective chirp rate is not reliable (e.g., due to errors or low level of confidence), the WTRU will set the effective chirp rate to the chirp rate received in the configuration message and proceed to the next step, or alternatively the WTRU will terminate the procedure and send a failure report back to the Network.

In some embodiments, the WTRU determines chirp measurements are reliable, and performs chirp calibration procedure as normal (e.g., including measurements and/or reporting), increases the periodicity of chirp measurements and reporting, decreases the periodicity of chirp measurements and reporting, or any combination thereof.

In some embodiments, the WTRU fails to perform calibration of the chirp rate based on chirp rate requirements not being satisfied, no chirp error group being determined, no chirp error source being determined, sensing not being able to be triggered, or any combination thereof. In response to the WTRU failing to perform calibration of the chirp rate, the WTRU may terminate the sensing procedures, request for reconfiguration for chirp (e.g., change chirp rate), request for reconfiguration for sensing, pause sensing for a predefined period, report sensing measurements and chirp measurements and terminate, or any combination thereof.

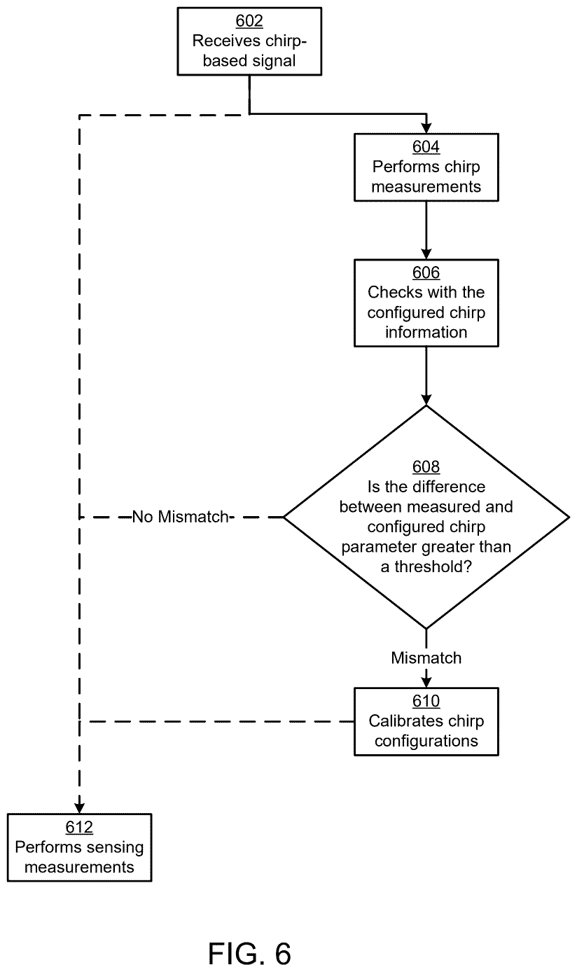

The WTRU may repeat the chirp rate calibration until a certain terminate condition is satisfied. In some embodiments, if no mismatch has been detected, the effective chirp rate is equal to the chirp rate received in the configuration message, as illustrated in FIG. 6.

FIG. 6 is an illustrative flow diagram of steps for a WTRU (e.g., WTRU 102a, 102b, 102c, 207, 707) receiving chirp-based RS(s) and performing chirp measurements, calibration if mismatch is detected, and post-calibration measurements, according to some embodiments of this disclosure. At 602, the WTRU may receive a chirp-based signal. At 604, the WTRU may perform chirp measurements. At 606, the WTRU may determine if the difference between the measured and configured chirp parameter (e.g., chirp rate) is greater than a threshold. At 610, if the WTRU determines that the difference between the measured and configured chirp parameter (e.g., chirp rate) is greater than a threshold, the WTRU may calibrate chirp configurations. At 612, the WTRU may perform sensing measurements (e.g., based on the calibrated chirp configurations).

In accordance with some embodiments of this disclosure, methods and systems for de-chirping of the received chirp signal are provided as follows. Following on the calibration step, the WTRU (e.g., WTRU 102a, 102b, 102c, 207, 707) may use the determined effective chirp rate to perform the de-chirping operation of the received chirp reference signal. The de-chirping operation may take as inputs chirp signal configuration (e.g., chirp rate, bandwidth, and/or duration), allocated resources for chirp transmission (e.g., time, frequency and space resources, number of OFDM symbols, sub-carriers, number of PRBs, and/or number of ports), the chirp information following the calibration step (e.g., measured chirp rate, measured set of frequencies, measured start and end time of the whole chirp, and/or measured start and end time of each of the measured frequencies), or any combination thereof. The output of the de-chirping operation may include measurements to evaluate the reliability of the de-chirping operation using the estimated effective chirp rate, and/or sensing measurements in accordance with the sensing task.

In accordance with some embodiments of this disclosure, methods and systems for verifying the reliability of measurements are provided as follows. The WTRU (e.g., WTRU 102a, 102b, 102c, 207, 707) may evaluate the reliability of the measurements it carried out (e.g., reliability and severity of the chirp rate detection mismatch, type of chirp rate detection mismatch, reliability of the effective chirp rate determination, and/or causes of error affecting the effective chirp rate determination). The WTRU may also determine alternative chirp configuration to minimize the chirp rate detection mismatch (e.g., reduced chirp rate, reduced chirp rate, and/or deactivation of chirp). In some embodiments, the WTRU uses the calibrated chirp rate to perform a set of measurements on the received and reflected signals. For example, the WTRU may obtain the AoA, ToA, TDoA, RSRP, RSRPP, SNR, doppler, RCS, the sensing measurements associated with target object with uncertainties (e.g., range, velocity, and/or lobes information), the channel responses measurements (e.g., CIR, PDP, and/or CFR), relative measurements (e.g., delta measurements with respect to the first set of measurements, without chirp), or any combination thereof.

In accordance with some embodiments of this disclosure, methods and systems for WTRU reporting are provided as follows. In some embodiments, the WTRU (e.g., WTRU 102a, 102b, 102c, 207, 707) performs sensing measurements and reports, sends, and/or recommends to the NW (e.g., gNB, LMF, and/or sensing entity) a report in periodic, aperiodic, or semi-persistent from over an uplink control or data channel. The WTRU may trigger to report, indicate, and/or include in the report sensing measurements associated with target object with uncertainties (e.g., range, velocity, and/or lobes information), relative measurements (e.g., delta measurements with respect to the first set of measurements (e.g., without chirp)), chirp-specific measurements (e.g., effective chirp rate, set of the obtained frequencies, start and end time of the obtained frequencies, start and end time of at least one of the obtained frequencies), absolute chirp measurements, relative chirp measurements with respect to the configured chirp, an indication of chirp rate mismatch, an indication of the difference between the measured chirp frequencies and the configured chirp frequencies, an indication of chirp calibration, sensing measurements associated with the calibrated chirp information (e.g., post calibration sensing measurements), an indication of effective chirp rate match, an indication of the error group of the mismatch based on the chirp mismatch measurements, an association between the sensing measurements, configured chirp information, and the chirp measurements, a recommendation for chirp configuration update, achieved accuracies, achieved uncertainties, information not related to target object (e.g., total number of NLOS groups and/or average RSRP), the measurement method used (e.g., absolute, relative), measurement search window (e.g., length of the window, type, method used to calculate, and/or start time of the window), the set of WTRU actions performed, or any combination thereof.

In some embodiments, the WTRU sends the report over any configured uplink control or data channel. The WTRU may be configured to send each report mode on preconfigured uplink control or data channel based on the report type and/or triggering event type (e.g., report mode 1 sent over PUSCH and/or report mode 2 sent over physical uplink control channel (PUCCH)). The measurement report may be transmitted through PUSCH (e.g., via RRC and/or via MAC control element (MAC-CE)) through a configured scheduling mechanism (e.g., configured grant).

In some embodiments, the WTRU is configured to send decoding information (e.g., report format, type of content, allocated fields for each measurement, and/or detected mismatch rate) for the report on specific uplink control or data channel. The gNB may blind-decode the received measurement sensing report from the WTRU. The WTRU may be configured to send its report to the network on a specific uplink control or data channel based on the measurement time granularity.

In some embodiments, the WTRU is configured to send its report to the network on a specific uplink control or data channel based on the report periodicity type (e.g., periodic, aperiodic, semi-persistent).

The WTRU may determine the event of chirp rate mismatch and report to the network in a periodic, aperiodic or semi-persistent form. The WTRU may be configured with specific reporting periodicity that is associated to the determined event (e.g., triggers for effective chirp rate matching, triggers may be impacting measurements, sensing configuration, and/or triggers may be impacting reporting for sensing measurements). The WTRU may be configured with a specific reporting periodicity that is associated to the reliability of sensing measurements.

In accordance with some embodiments of this disclosure, methods and systems for WTRU reporting updates are provided as follows. The WTRU may perform measurements on the RS reflected from the target and/or WTRU over multiple measurement occasions (e.g., multi-slot level (e.g., repetition factor and/or time gap configurations)). The WTRU may determine that the sensing measurement report may be invalid or outdated based on the change of one or more of sensing measurements over or below and preconfigured threshold, the change of event detected (e.g., chirp rate mismatch to effective chirp rate match), the change of environment (e.g., captured by change in CIR, PDP, and/or DP), the change of triggering event conditions, the change in the measured RS metric(s) and/or KPI(s) over a preconfigured threshold, receiving update request by other entity (e.g., gNB, LMF, and/or SF), or any combination thereof.

The WTRU may perform new sensing measurements based on the change of one or more of sensing measurements over or below and preconfigured threshold, the change of event detected (e.g., chirp rate mismatch to effective chirp rate match), the change of environment (e.g., captured by change in CIR, PDP, and/or DP), the change of triggering event conditions, the change in the measured RS metric(s) and/or KPI(s) over a preconfigured threshold, receiving update request by other entity (e.g., gNB, LMF, and/or SF), or any combination thereof. The WTRU may determine to send an updated sensing report in aperiodic, periodic or semi-persistent form over an UL control or data channel. The updated sensing report may comprise a time stamp of the updated measurements (e.g., in absolute or relative time, number of slots, and/or frames) relative to a known reference, updated antenna ports involved in the measurements, updated reference signal resources employed in the measurements, updated sensing measurements and uncertainties, updated chirp rate mismatch, or any combination thereof.

In accordance with some embodiments of this disclosure, methods and systems for WTRU reporting exit, failure, and/or termination conditions are provided as follows. The WTRU (e.g., WTRU 102a, 102b, 102c, 207, 707) may be configured to perform the measurements over multiple measurement occasions (e.g., multi-slot level (e.g., repetition factor and/or time gap configurations)). The WTRU may determine that reporting the sensing measurements may be terminated based on the determination of sensing chirp rate mismatch below or above a preconfigured threshold for a configured threshold time or configured number of measurement occasions, the determination of one or more of the sensing measurements below or above a preconfigured threshold for a configured threshold time or configured number of measurement occasions, the determination of no change in one or more of the sensing measurements over a predefined period, the determination of no change in chirp rate mismatch over a predefined period, the determination of no change in one or more of the metrics or KPIs over a predefined period, achieving the sensing requirements over a predefined period, a time elapsed since the last reporting of precoding feedback information exceeding a maximum absolute or relative duration, a low-battery indication by the WTRU, a termination indication by the network, or any combination thereof.

In some embodiments, based on any of the above conditions for the WTRU determining that reporting the sensing measurements may be terminated, the WTRU terminates the procedure of detecting and reporting chirp rate mismatch and may send a report over an UL control or data channel containing the recommendation to terminate the measurement procedure. The report may comprise a termination indicator (e.g., referring to the reason of termination). For example, termination indicator equal to 1 may refer to a chirp rate mismatch doesn't change for N measurement occasions, while an indicator value equal to 2 may refer to chirp rate mismatch doesn't change for M measurement occasions. The report may comprise a termination time stamp, a detailed termination reason, the latest sensing report (e.g., requested information, measurements performed, detected mismatch rate, existing triggering conditions, WTRU behaviour performed, time stamps, and/or RS signal ID used for sensing), or any combination thereof.

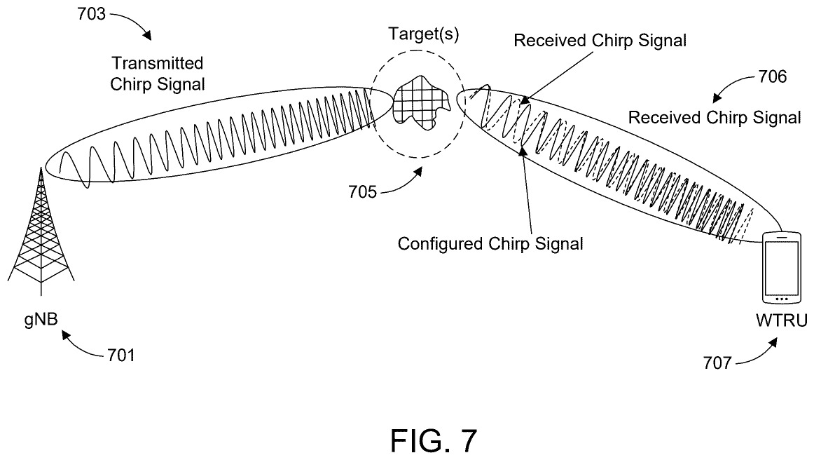

FIG. 7 is an illustrative diagram of the mismatch between a transmitted chirp signal (e.g., transmitted chirp signal 703) and a received chirp signal (e.g., received chirp signal 706) as measured by a receiver (e.g., WTRU 102a, 102b, 102c, 207, 707), as a result of hardware imperfections and/or channel variations, according to some embodiments of this disclosure. The chirp-based signal may be transmitted by a transmitter (e.g., gNB 180a, 180b, 180c, 201, 701), reflected at a target (e.g., target 205, 705), and received at a receiver (e.g., WTRU 102a, 102b, 102c, 207, 707).

In accordance with some embodiments of this disclosure, implementation examples are provided as follows. In some embodiments, the WTRU (e.g., WTRU 102a, 102b, 102c, 207, 707) is configured with an LFM chirp-based RS, with specific set of frequencies (e.g., f₁, f₂, . . . , f_{Nchirp}), where the i^{th} frequency ends the time tᵢ, and the chirp's time window is T_{chirp}. The WTRU may receive the chirp-based RS with a mismatch in the chirp rate due hardware imperfections of channel variation as shown in FIG. 7.

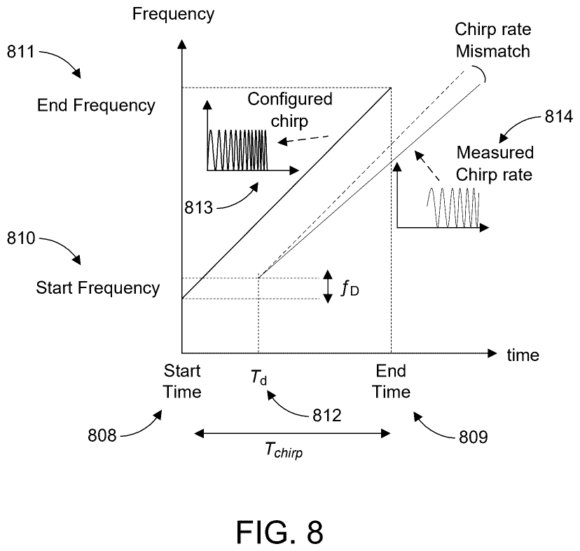

FIG. 8 is an illustrative diagram of the mismatch of the configured and measured chirp rates in a time vs. frequency representation, according to some embodiments of this disclosure. FIG. 8 illustrates the start time 808 and end time 809 of the chirp signals (e.g., transmitted chirp signal 703, transmitted chirp signal 813, received chirp signal 706, received chirp signal 814) in the x-axis, and the start frequency 810 and end frequency 811 of the chirp signals in the y-axis.

The WTRU (e.g., WTRU 102a, 102b, 102c, 207, 707) may perform a set of chirp measurements using the received chirp-based RS and a mismatch is observed in the chirp rate, as shown in FIG. 8. In FIG. 8, the configured chirp signal is transmitted between start time 808 and end time 809 (i.e., during the time window T_{chirp}), over a set of frequencies. The WTRU begins receiving the chirp signal at T_{d}, which denotes the delay (e.g., delay 812) due to reflection at the target (e.g., target 205, 705), with a shift in frequency by f_{D}. Additionally, a change in the slope in the frequency vs. time plot of the received chirp relative to the configured chirp is observed due to the mismatch between the configured and received chirp signals.

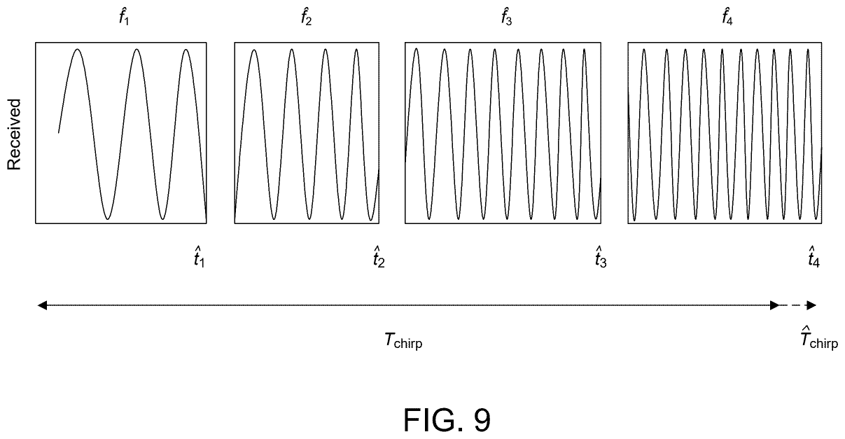

FIG. 9 is an illustrative diagram of the set of measured characteristics of the received chirp-based signal, according to some embodiments of this disclosure.

In some embodiments, the WTRU (e.g., WTRU 102a, 102b, 102c, 207, 707) obtains the set of chirp measurements, illustrated in FIG. 9, which comprises the start set of operating Nchirp frequencies (e.g., \hat{f}₁, \hat{f}₂, . . . \hat{f}_{Nchirp}), the chirp bandwidth, the chirp rate (e.g., the slope of chirp frequencies variation), the start and end time of each of the measured frequencies, (e.g., \hat{t}₁, \hat{t}₂, . . . , \hat{t}_{Nchirp}), the received chirp duration (e.g., \hat{T}_{chirp}), or any combination thereof.

In some embodiments, the WTRU uses the chirp configuration to determine if a chirp rate mismatch is detected (e.g., between the configured chirp and the measured chirp). If a mismatch is detected, the WTRU may (a) perform calibration of the chirp rate (e.g., replace the configured chirp information with the measured chirp information), (b) perform a set of sensing measurement using the calibrated chirp information (e.g., perform range and velocity estimation using the measured chirp information (e.g., measured frequencies, measured start and end time of each frequency or all chirp)), (c) indicate to the network that a calibration has been applied, (d) report to the network the post-calibration sensing measurements, (e) report an association between the measured chirp information and the obtained sensing measurements, (f) indicate to the network the chirp measurements, (g) indicate to the network the effective chirp rate, (h) indicate to the network the difference between the measured chirp frequencies and the configured chirp frequencies, (i) indicate to the network the chirp rate mismatch, (j) indicate to the network the chirp rate mismatch error group, (k) indicate to the network a recommendation for chirp configuration update, or (l) indicate to the network the set of WTRU actions performed, or any combination thereof.

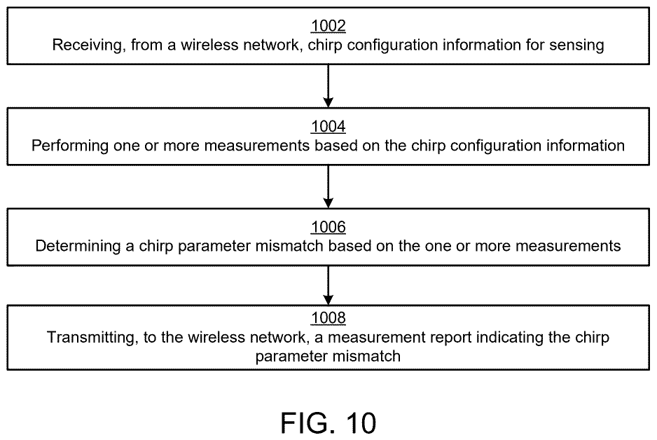

FIG. 10 is an illustrative flow diagram of steps for detecting and reporting chirp mismatch, according to some embodiments of this disclosure.

At 1002, the WTRU (e.g., WTRU 102a, 102b, 102c, 207, 707) may receive, from a wireless network, chirp configuration information for sensing. In some embodiments, the chirp configuration information indicates at least one of a chirp rate, a chirp duration, a chirp bandwidth, a chirp frequency (e.g., start frequency 210, start frequency 810, end frequency 211, end frequency 211, any configured frequency of 501), a chirp start time (e.g., start time 208, 808), and/or a chirp end time (e.g., end time 209, 809).

At 1004, the WTRU may perform one or more measurements based on the chirp configuration information. In some embodiments, the one or more measurements are associated with one or more of: of a chirp frequency, a chirp start time, a chirp end time, a start time of a frequency, an end time of a frequency, an effective chirp rate, a measured chirp rate to configured chirp rate ratio, or chirp linearity. In some embodiments, the WTRU performs de-chirping of a received chirp reference signal based on the chirp configuration information.

At 1006, the WTRU may determine a chirp parameter mismatch based on the one or more measurements. In some embodiments, determining the chirp parameter mismatch comprises determining 1) a difference between a measured chirp rate and a configured chirp rate, or 2) a ratio between the measured chirp rate and the configured chirp rate. In some embodiments, the WTRU performs a calibration based on the chirp parameter mismatch. The calibration may comprise one of replacing one or more parameters of the chirp configuration information with measured chirp information, or performing one or more sensing measurements using the measured chirp information.

At 1008, the WTRU may transmit, to the wireless network, a measurement report indicating the chirp parameter mismatch. In some embodiments, the measurement report indicates that the difference or the ratio between the measured chirp rate and the configured chirp rate is above or below a threshold. In some embodiments, the measurement report indicates measured chirp information. In some embodiments, the measurement report indicates that the chirp parameter mismatch is above or below a threshold (e.g., correlation threshold 503). In some embodiments, the measurement report indicates at least one of the one or more measurements, calibration information, a recommendation for a chirp configuration update, or post-calibration measurements.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and/or receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ✓6 or means-plus-function claim format, and any claim without the terms “means for” is not so intended.

What is claimed is:

1. A method performed by a wireless transmit/receive unit, the method comprising:
receiving, from a wireless network, chirp configuration information for sensing;
performing one or more measurements based on the chirp configuration information;
determining a chirp parameter mismatch based on the one or more measurements; and
transmitting, to the wireless network, a measurement report indicating the chirp parameter mismatch.

2. The method of claim 1, wherein the chirp configuration information indicates at least one of a chirp rate, a chirp duration, a chirp bandwidth, a chirp frequency, a chirp start time, or a chirp end time.

3. The method of claim 1, wherein the one or more measurements are associated with one or more of: a chirp frequency, a chirp start time, a chirp end time, a start time of a frequency, an end time of a frequency, an effective chirp rate, a measured chirp rate to configured chirp rate ratio, or chirp linearity.

4. The method of claim 1, wherein determining the chirp parameter mismatch comprises determining 1) a difference between a measured chirp rate and a configured chirp rate, or 2) a ratio between the measured chirp rate and the configured chirp rate.

5. The method of claim 4, wherein the measurement report indicates that the difference or the ratio between the measured chirp rate and the configured chirp rate is above or below a threshold.

6. The method of claim 1, further comprising:
performing a calibration based on the chirp parameter mismatch, wherein the calibration comprises one of:
replacing one or more parameters of the chirp configuration information with measured chirp information; or
performing one or more sensing measurements using the measured chirp information.

7. The method of claim 1, further comprising:
performing de-chirping of a received chirp reference signal based on the chirp configuration information.

8. The method of claim 1, wherein the measurement report indicates measured chirp information.

9. The method of claim 1, wherein the measurement report indicates that the chirp parameter mismatch is above or below a threshold.

10. The method of claim 1, wherein the measurement report indicates at least one of the one or more measurements, calibration information, a recommendation for a chirp configuration update, or post-calibration measurements.

11. A wireless transmit/receive unit (WTRU) that is in communication with a wireless network, the WTRU comprising a processor and a transceiver, wherein the WTRU is configured to:
receive, from the wireless network, chirp configuration information for sensing;
perform one or more measurements based on the chirp configuration information;
determine a chirp parameter mismatch based on the one or more measurements; and
transmit, to the wireless network, a measurement report indicating the chirp parameter mismatch.

12. The WTRU of claim 11, wherein the chirp configuration information indicates at least one of a chirp rate, a chirp duration, a chirp bandwidth, a chirp frequency, a chirp start time, or a chirp end time.

13. The WTRU of claim 11, wherein the one or more measurements are associated with one or more of: a chirp frequency, a chirp start time, a chirp end time, a start time of a frequency, an end time of a frequency, an effective chirp rate, a measured chirp rate to configured chirp rate ratio, or chirp linearity.

14. The WTRU of claim 11, wherein determining the chirp parameter mismatch comprises determining 1) a difference between a measured chirp rate and a configured chirp rate, or 2) a ratio between the measured chirp rate and the configured chirp rate.

15. The WTRU of claim 14, wherein the measurement report indicates that the difference or the ratio between the measured chirp rate and the configured chirp rate is above or below a threshold.

16. The WTRU of claim 11, further configured to:
perform a calibration based on the chirp parameter mismatch, wherein the calibration comprises one of:
replacing one or more parameters of the chirp configuration information with measured chirp information; or
performing one or more sensing measurements using the measured chirp information.

17. The WTRU of claim 11, further configured to:
perform de-chirping of a received chirp reference signal based on the chirp configuration information.

18. The WTRU of claim 11, wherein the measurement report indicates measured chirp information.

19. The WTRU of claim 11, wherein the measurement report indicates that the chirp parameter mismatch is above or below a threshold.

20. The WTRU of claim 11, wherein the measurement report indicates at least one of the one or more measurements, calibration information, a recommendation for a chirp configuration update, or post-calibration measurements.
